(19) United States
(12) Patent Application Publication
(10) Pub. No.: US 2015/0281674 A1
(43) Pub. Date: Oct. 1, 2015

(54) STEREO ADAPTER AND STEREO IMAGING APPARATUS

(71) Applicant: FUJITSU LIMITED, Kawasaki-shi (JP)

(72) Inventors: Teruyuki Sato, Tama (JP); Norihiro Kakuko, Kawasaki (JP)

(21) Appl. No.: 14/615,591

(22) Filed: Feb. 6, 2015

(30) Foreign Application Priority Data
Mar. 28, 2014 (JP) 2014-070005

(51) Int. Cl. H04N 13/02; G03B 35/10

(52) U.S. Cl. CPC H04N 13/0225; G03B 35/10

(57) ABSTRACT

A stereo adapter includes first and second reflecting surfaces disposed in a front of an imaging unit along a direction perpendicular to a parallax direction, a third reflecting surface disposed further away from the imaging unit than the first reflecting surface along the parallax direction, and a fourth reflecting surface disposed further away from the imaging unit than the second reflecting surface along the parallax direction and on an opposite side of the third reflecting surface. Each reflecting surface is rotated by a predetermined angle from an entrance pupil plane or an object plane around a first axis orthogonal to the parallax direction and the optical axis and is tilted such that a ray in parallel to the optical axis when entry forms an angle of a quarter of a vertical angle of view of the imaging unit to the optical axis when leaving from the stereo adapter.

### CROSS-REFERENCE TO RELATED APPLICATION

This application is based upon and claims the benefit of priority of the prior Japanese Patent Application No. 2014-070005, filed on Mar. 28, 2014, and the entire contents of which are incorporated herein by reference.

### FIELD

The embodiments discussed herein are related to a stereo adapter capable of shooting a subject from two different directions and a stereo imaging apparatus which generates a stereo image by using such a stereo adapter.

### BACKGROUND

Research for reproducing stereoscopic images has been proceeding for many years. Methods to reproduce stereoscopic images have been known, in one of which two images captured by imaging a subject from different directions are displayed side by side to present one image to the left eye of the viewer and the other image to the right eye. A pair of images used in such a method is referred to as a stereo image.

A stereo adapter mounted on the front of an imaging lens of a monocular camera has been known in which two images of a subject as viewed from different directions are focused on respective left and right halves of an image plane of the camera in order to generate a stereo image (for example, refer to Japanese Laid-open Patent Publication No. H01-279235). The stereo adapter includes, for example, two pairs of two mirrors disposed axisymmetrically with respect to the horizontal center of the stereo adapter such that each of images of the subject as viewed from two different directions can be imaged on the camera. An inner mirror included in each pair of mirrors is positioned in front of the imaging lens and its reflecting surface is disposed to face the imaging lens and to be tilted toward the horizontal direction with respect to the optical axis of the imaging lens. Each inner mirror directs, toward the imaging lens, a light flux from the subject reflected by each outer mirror which is disposed in the horizontal direction and outwardly of the inner mirror with respect to the imaging lens and whose reflecting surface is oriented toward the subject. In this way, the images of the subject as viewed the subject from each position of the outer mirrors are formed on respective left and right halves of the image plane of the imaging lens. Accordingly, a stereo image can be obtained by trimming regions, in which images of the subject are captured, from the left and right halves of the image obtained by shooting the subject using the stereo adapter and by setting them to respective images for the left and right eyes.

However, when a stereo image is generated using the stereo adapter disclosed in Japanese Laid-open Patent Publication No. H01-279235, an angle of view of each of the images for the left and right eyes in a parallax direction, which is a direction that produces a parallax, is one half of a horizontal angle of view of the imaging lens. As a result, a range of the parallax direction contained in each image is narrow. In order to solve this problem, it is conceivable, by using two cameras, to separately and respectively generate an image for the left eye and an image for the right eye. However, when the subject is a moving object, when capturing timings of the two cameras are not synchronized, a position of the subject captured in the left-eye image and a position of the subject captured in the right-eye image result in being different. As a result, it will be difficult to correctly reproduce a stereoscopic image from the left-eye image and the right-eye image. In particular, when using a stereo image for measuring a distance to a moving object, failure to correctly reproduce the stereoscopic image will result in significant decrease in measurement accuracy. Therefore, in order to generate a stereo image using two cameras, there arises a need to provide a configuration for synchronizing capturing timings of the two cameras.

On the other hand, with respect to an attachment for capturing stereo images, techniques have been proposed which widen the field of view in the parallax direction by directing a light flux for the left eye and a light flux for the right eye so as to be arranged side by side in a direction perpendicular to the parallax direction on an imaging lens (for example, refer to Japanese Laid-open Patent Publication Nos. H07-134345, 2000-81331, H08-171151, H08-234339, and 2004-4869).

It has been proposed that quality of an image for each eye is improved by performing an imaging process such as a blurring correction and a noise removal on respective images for the left and right eyes obtained by using an attachment for capturing stereo images (refer to Japanese Laid-open Patent Publication No. 2012-182738).

### SUMMARY

When a light flux for the left eye and a light flux for the right eye are arranged side by side in a direction perpendicular to the parallax direction, positions of a subject in images for the left eye and the right eye are misaligned in the direction perpendicular to the parallax direction. In the techniques described in Japanese Laid-open Patent Publication Nos. H07-134345, 2000-81331, H08-171151, H08-234339, and 2004-4869 listed above, optical systems of the attachment for compensating the positional misalignment become complex and, as a result, the size as well as cost of the attachment increases.

For example, in the technique disclosed in Japanese Laid-open Patent Publication No. H07-134345, a prism is used in order to compensate for a positional misalignment in the vertical direction between a light flux for the left eye and a light flux for the right eye.

On the other hand, in the technique disclosed in Japanese Laid-open Patent Publication No. 2000-81331, a light flux for the left eye and a light flux for the right eye are each rotated by 90° with a doped prism and are focused side by side on an image sensor.

Furthermore, in the techniques disclosed in Japanese Laid-open Patent Publication Nos. H08-171151, H08-234339, and 2004-4869, the attachment has substantially a binocular configuration since each of an optical system for the left eye and an optical system for the right eye includes a focusing lens. Accordingly, in order to mount the attachment in the front of the imaging optical system to use, a converging lens is required which re-collimates light fluxes which are lights converged by each focusing lens. Therefore, it becomes difficult for a user to handle the attachment since the attachment itself becomes large. Furthermore, the cost of the attachment also increases due to complication of the optical system.

On the other hand, in a technique disclosed in Japanese Laid-open Patent Publication No. 2012-182738, in order to divide a light flux to generate an image for the right eye and a light flux to generate an image for the left eye, a mirror mechanism is used which has two mirrors for each of the right eye and the left eye and is disposed in the front of an imaging optical system. Thus, a stereo image is generated using a simple optical system in the technique disclosed in Japanese Laid-open Patent Publication No. 2012-182738. However, since only those processes such as a blurring correction and a noise removal are performed in an imaging process of the technique, an image tilt due to an orientation of each mirror is not corrected and, as a result, an area common to the image for the right eye and the image for the left eye are not effectively utilized.

According to one embodiment, a stereo adapter which is disposed in the front of an imaging unit which generates an image by shooting a subject is provided. The stereo adapter includes, in the front of the imaging unit, first and second reflecting surfaces which are disposed along a direction perpendicular to a parallax direction, a third reflecting surface which is disposed at a position further away from the imaging unit along the parallax direction than the first reflecting surface, and a fourth reflecting surface which is disposed at a position further away from the imaging unit along the parallax direction than the second reflecting surface and at a position opposite to the third reflecting surface with respect to an optical axis of the imaging unit. The first reflecting surface is rotated by a first angle with respect to an entrance pupil plane of the imaging unit around a first axis orthogonal to the parallax direction and the optical axis so as to face the imaging unit and the third reflecting surface and is rotated by a second angle from a direction perpendicular to a plane including the optical axis and the parallax direction toward the optical axis around an axis parallel to the first reflecting surface and orthogonal to the first axis. The third reflecting surface is rotated by the first angle with respect to an object plane, which is in an image-forming relationship with an image plane of the imaging unit, around the first axis so as to face the first reflecting surface and the subject and is rotated by a third angle from a direction perpendicular to the plane including the optical axis and the parallax direction around an axis parallel to the third reflecting surface and orthogonal to the first axis. The second reflecting surface is rotated by the first angle with respect to the entrance pupil plane of the imaging unit in a direction opposite to a rotational direction of the first reflecting surface around the first axis so as to face the imaging unit and the fourth reflecting surface and is rotated by the second angle from the direction perpendicular to the plane including the optical axis and the parallax direction toward the optical axis around an axis parallel to the second reflecting surface and orthogonal to the first axis. The fourth reflecting surface is rotated by the first angle in a direction opposite to a rotational direction of the third reflecting surface with respect to the object plane around the first axis so as to face the second reflecting surface and the subject and is rotated by the third angle in a direction opposite to a rotational direction of the third reflecting surface from the direction perpendicular to the plane including the optical axis and the parallax direction around an axis parallel to the fourth reflecting surface and orthogonal to the first axis.

Furthermore, a total of the second angle and the third angle is set such that a ray parallel to the optical axis of the imaging unit when entering the stereo adapter among a first light flux which enters the imaging unit from the subject via the third reflecting surface and the first reflecting surface approaches the optical axis with an angle of a quarter of a vertical angle of view of the imaging unit with respect to the optical axis when leaving from the stereo adapter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a digital camera, which is an example of a stereo imaging apparatus, with a stereo adapter mounted thereon.

FIG. 2A is a plan view of an optical system of the stereo adapter.

FIG. 2B is a side view of the optical system of the stereo adapter as viewed from the direction of an arrow A illustrated in FIG. 2A.

FIG. 2C is a side view of the optical system of the stereo adapter as viewed from the direction of an arrow B illustrated in FIG. 2A.

FIG. 3 is a diagram illustrating an example of a relative positional relationship between mirrors of one of pairs of mirrors of the stereo adapter.

FIG. 4 is a diagram illustrating a relationship between an incident angle of an incident light to a reflecting surface and a reflection angle of a reflected light.

FIG. 5 is a diagram illustrating an example of a relationship between an incident angle and a reflection angle of a ray by each mirror of one of the pairs of mirrors of the stereo adapter.

FIG. 6A represents an example of an image generated by an imaging unit when a forward tilt angle of an outer mirror is 0°.

FIG. 6B represents an example of an image generated by the imaging unit when the forward tilt angle of the outer mirror is provided.

FIG. 6C represents an example of an image generated by the imaging unit when a forward tilt angle of an inner mirror is adjusted according to the forward tilt angle of the outer mirror.

FIG. 7 is a diagram representing a relationship between a forward tilt angle of the inner mirror and a boundary between subject regions on an image.

FIG. 8A illustrates an example of a combination of a forward tilt angle of the inner mirror and a tilt with respect to the horizontal direction of a boundary between two upper and lower subject regions on an image.

FIG. 8B illustrates an example of a combination of a forward tilt angle of the inner mirror and a tilt with respect to the horizontal direction of a boundary between two upper and lower subject regions on the image.

FIG. 8C illustrates an example of a combination of a forward tilt angle of the inner mirror and a tilt with respect to the horizontal direction of a boundary between two upper and lower subject regions on the image.

FIG. 9 is a diagram illustrating a trajectory of a ray in the vertical direction when the inner mirror and the outer mirror each are disposed so as to form an angle of 45° in the horizontal plane with respect to the optical axis of the imaging unit.

FIG. 10A is a diagram illustrating a simulation result of an image obtained according to a combination of a forward tilt angle of the inner mirror and a forward tilt angle of the outer mirror.

FIG. 10B is a diagram illustrating a simulation result of an image obtained according to a combination of a forward tilt angle of the inner mirror and a forward tilt angle of the outer mirror.

FIG. 10C is a diagram illustrating a simulation result of an image obtained according to a combination of a forward tilt angle of the inner mirror and a forward tilt angle of the outer mirror.

FIG. 11A is a diagram illustrating a rotation of the imaging unit with respect to the stereo adapter to correct a rotation of the subject.

FIG. 11B is a diagram illustrating an example of an image in which the rotation of the subject is corrected by the rotation of the imaging unit with respect to the stereo adapter.

FIG. 12 is a configuration diagram of a stereo image generating apparatus.

FIG. 13 is a diagram illustrating a relationship between an object plane and a vertical plane which does not cause a trapezoidal distortion.

FIG. 14 is a diagram illustrating a model of a planar projective transformation.

FIG. 15 is a diagram illustrating a variation of the model of the planar projective transformation.

FIG. 16 is an operational flowchart of a stereo image generation process.

### DESCRIPTION OF EMBODIMENTS

A stereo adapter and a stereo imaging apparatus with the stereo adapter mounted thereon according to an embodiment will be explained with reference to the drawings. The stereo imaging apparatus generates a stereo image from an image obtained by shooting a subject using the stereo adapter with two pairs of mirrors which directs each light flux such that light fluxes for the right eye and the left eye enter an imaging optical system of a monocular camera side by side along a direction perpendicular to a parallax direction. The stereo adapter directs the light flux for the left eye such that a ray among the light flux for the left eye parallel to an optical axis of the imaging optical system when entering the stereo adapter approaches to the light flux for the right eye with a predetermined angle with respect to the optical axis when leaving from the stereo adapter. Similarly, the stereo adapter directs the light flux for the right eye such that a ray among the light flux for the right eye parallel to the optical axis of the imaging optical system when entering the stereo adapter approaches to the light flux for the left eye with a predetermined angle with respect to the optical axis when leaving from the stereo adapter. The stereo imaging apparatus divides the image into an image for the left eye and an image for the right eye along a direction perpendicular to the parallax direction.

Furthermore, in the stereo adapter, a tilt of each mirror is set such that a difference between a tilt of a boundary between a subject region formed by the light flux for the left eye and a subject region formed by the light flux for the right eye on the image and a tilt of the parallax direction becomes small.

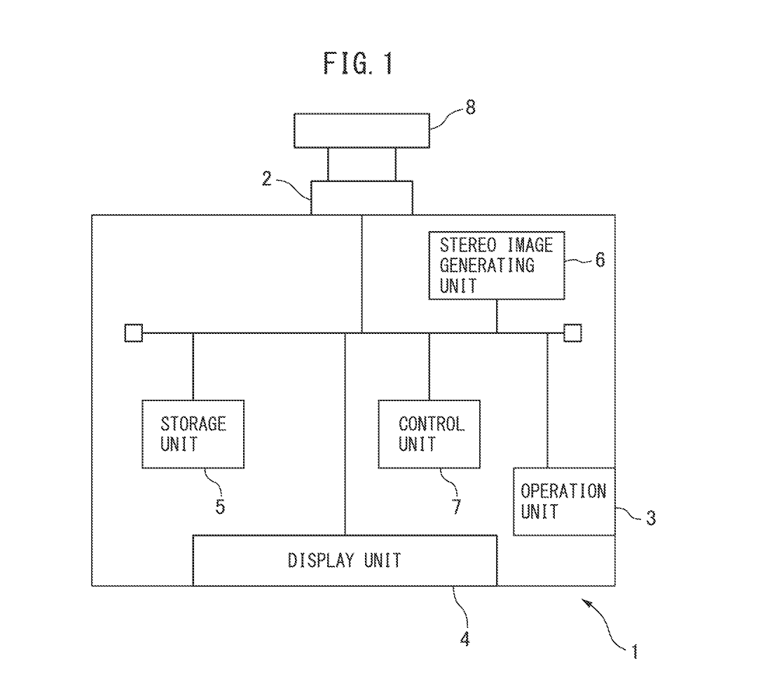

FIG. 1 is a schematic diagram of a digital camera with a stereo adapter mounted thereon. As illustrated in FIG. 1, a digital camera 1 is an example of a stereo imaging apparatus and includes an imaging unit 2, an operation unit 3, a display unit 4, a storage unit 5, a stereo image generating apparatus 6, a control unit 7, and a stereo adapter 8. The digital camera 1 may further include an interface circuit (not illustrated) conforming to a serial bus standard such as Universal Serial Bus in order to connect the digital camera 1 to other apparatus such as a computer or a television receiver. The control unit 7 is connected to other units of the digital camera 1, for example, via a bus.

The imaging unit 2 includes an image sensor with an array of solid-state imaging elements arranged in two dimensions and an imaging optical system in which images captured of a subject are formed on the upper half and the lower half of the image sensor via the stereo adapter 8. The imaging unit 2 generates the image of the subject in a region of an upper half and a region of a lower half of the image. Each time the image is generated, the imaging unit 2 transmits the generated image to the stereo image generating apparatus 6.

The operation unit 3 includes, for example, various types of operating buttons or dial switches with which a user operates the digital camera 1. In response to a user's operation, the operation unit 3 transmits a control signal, for example, for initiating capturing or focusing or a setup signal for setting a shutter speed, an aperture opening, and the like to the control unit 7.

The display unit 4 includes, for example, a display device such as a liquid crystal display device and displays various types of information received from the control unit 7 or images generated by the imaging unit 2. Note that the operation unit 3 and the display unit 4 may be combined into one unit using, for example, a touch panel display.

The storage unit 5 includes, for example, a readable and writable volatile or nonvolatile semiconductor memory circuit. The storage unit 5 stores stereo images generated by the stereo image generating apparatus 6. Furthermore, the storage unit 5 may store images received from the imaging unit 2. In addition, when each function included in the stereo image generating apparatus 6 is implemented by a computer program executed on a processor included in the control unit 7, the computer program may be stored in the storage unit 5.

From an image obtained by shooting a subject using the stereo adapter 8, the stereo image generating apparatus 6 trims, as an image for the left eye, a region containing the subject's image represented in an upper half of the image and trims, as an image for the right eye, a region containing the subject's image represented in a lower half of the image. Note that, in the following, the image for the left eye will be referred to as a left image and the image for the right eye will be referred to as a right image for convenience. The stereo image generating apparatus 6 corrects trapezoidal distortion of the subject on the left image and the right image caused by a pair of mirrors of the stereo adapter 8. Note that the stereo image generating apparatus 6 will be described in detail later.

The control unit 7 includes at least one processor and peripheral circuitry thereof. The control unit 7 controls the entire digital camera 1.

The stereo adapter 8 is detachably mounted on the front of an imaging lens system included in the imaging unit 2. For this purpose, the stereo adapter 8 includes a mounting mechanism (not illustrated) to mount the stereo adapter 8 on the front of the imaging unit 2. Furthermore, the stereo adapter 8 includes two pairs of mirrors to form the subject's images as viewed from two different directions on an image plane of the imaging unit 2. Note that the stereo adapter 8 and the imaging unit 2 may be integrated into a single lens barrel.

In the present embodiment, the stereo adapter 8 is mounted on the imaging unit 2 such that the parallax direction becomes a horizontal direction and a direction perpendicular to the parallax direction becomes a vertical direction. Accordingly, angles of view of the parallax direction of the left image and the right image are approximately equal to a horizontal angle of view of the imaging unit 2.

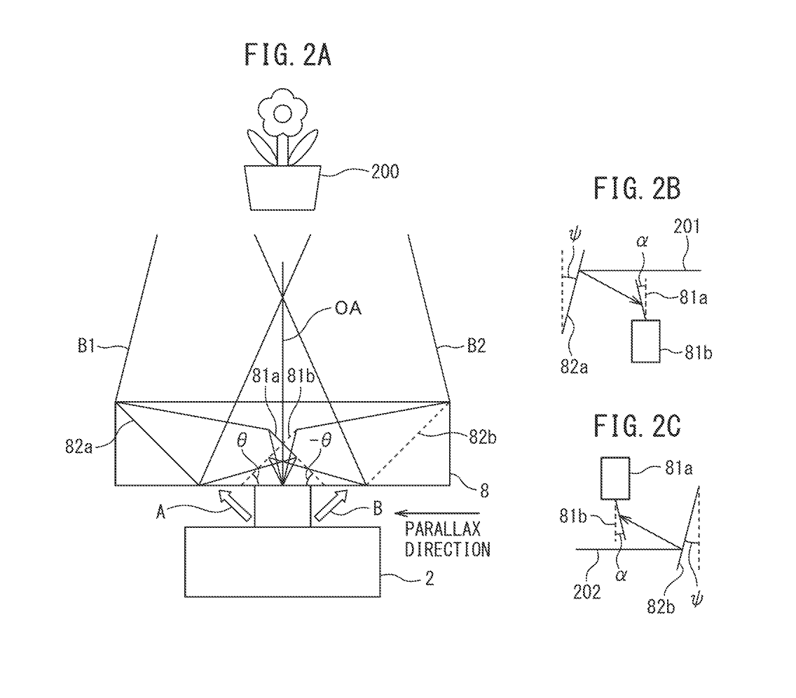

FIG. 2A is a plan view of an optical system of the stereo adapter 8. FIG. 2B is a side view of the optical system of the stereo adapter as viewed from a direction of an arrow A illustrated in FIG. 2A. FIG. 2C is a side view of the optical system of the stereo adapter as viewed from a direction of an arrow B illustrated in FIG. 2A. As illustrated in FIGS. 2A to 2C, the stereo adapter 8 includes therein a pair of mirrors 81a and 82a for the left eye and a pair of mirrors 81b and 82b for the right eye. In the present embodiment, each mirror is a flat mirror with no optical power. Note that the mirrors 81a and 82a for the left eye and the mirrors 81b and 82b for the right eye are axisymmetrically disposed with respect to an optical axis OA of the imaging unit 2 in the horizontal direction of the stereo adapter 8 in a state of being mounted on the digital camera 1. The mirrors 81a and 81b are disposed in the front of the imaging optical system of the imaging unit 2 and disposed side by side along the vertical direction of the stereo adapter 8, i.e., along the direction perpendicular to the parallax direction. Note that a horizontal plane including the optical axis OA of the imaging unit 2 becomes a boundary between the mirror 81a and the mirror 81b.

The mirrors 82a and 82b respectively reflect light fluxes B1 and B2 from a subject 200 toward the mirrors 81a and 81b. The light fluxes B1 and B2 are respectively reflected by the mirrors 81a and 81b to enter the imaging optical system of the imaging unit 2. An orientation of each mirror is adjusted such that the subject 200 is imaged on both the upper half region and the lower half region on the image sensor of the imaging unit 2.

In particular, the mirror 81a is disposed such that a reflecting surface thereof faces an imaging unit 2 and is rotated by an angle −θ, for example, −45° around a vertical axis with respect to an entrance pupil plane of the imaging unit 2. On the other hand, the mirror 81b is disposed such that a reflecting surface thereof faces the imaging unit 2 and is rotated by an angle θ in a direction opposite to that of the mirror 81a, for example, 45° around the vertical axis with respect to the entrance pupil plane of the imaging unit 2. Note that the angle θ is positive when a direction of rotation is counterclockwise with respect to the entrance pupil plane.

The mirrors 82a and 82b are disposed outwardly of the mirrors 81a and 81b. The reflecting surfaces thereof are oriented toward a subject. The mirror 82a is disposed such that the reflecting surface thereof is rotated by θ° around the vertical axis with respect to an object plane in an image-forming relationship with an image plane of the imaging unit 2. In other words, the mirror 82a is disposed, being rotated by an angle (π−θ), for example, 135° around the vertical axis with respect to the entrance pupil plane of the imaging unit 2. On the other hand, the mirror 82b is disposed such that the reflecting surface thereof is rotated by −θ° in a direction opposite to that of the mirror 82a around the vertical axis with respect to the object plane. In other words, the mirror 82b is disposed, being rotated by an angle (θ−π), for example, −135° around the vertical axis with respect to the entrance pupil plane of the imaging unit 2.

When each mirror is disposed such that the reflecting surface of each mirror becomes parallel to the vertical direction, the light flux B1 passes above a horizontal plane including the optical axis of the imaging unit 2 while the light flux B2 passes below the horizontal plane. As a result, since a subject's image contained in the upper half and a subject's image contained in the lower half of an image generated by the imaging unit 2 do not include a common portion, the stereo image generating apparatus 6 is unable to generate a stereo image from the image.

Accordingly, the mirror 81a is rotated by an angle α around a horizontal axis parallel to the reflecting surface, so that the reflecting surface is tilted toward the optical axis OA from the vertical direction, in order that the light fluxes B1 and B2 at least partially overlap on the object side away from the stereo adapter 8. Similarly, the mirror 81b is rotated by an angle (−α) around a horizontal axis orthogonal to the vertical axis and parallel to the reflecting surface so that the reflecting surface is tilted toward the optical axis OA from the vertical direction. The angle α is set such that the parallax direction and a boundary between the left and right images become parallel as much as possible on the image sensor of the imaging unit 2. Note that a determining method of the angle α will be described in detail later.

The reflecting surface of the mirror 82a is rotated by an angle ψ from the vertical direction around an axis orthogonal to the vertical axis and parallel to the reflecting surface. Similarly, the reflecting surface of the mirror 82b is rotated by an angle (−ψ) from the vertical direction around an axis orthogonal to the vertical axis and parallel to the reflecting surface. Accordingly, an incident ray 201 parallel to the optical axis OA is reflected by the mirror 82a downwards with respect to the horizontal plane including the optical axis OA according to the rotation angle. On the contrary, an incident ray 202 parallel to the optical axis OA is reflected by the mirror 82b upwards with respect to the horizontal plane including the optical axis OA according to the rotation angle. Note that the rotation angle α and the rotation angle ψ are referred to as a forward tilt angle for convenience.

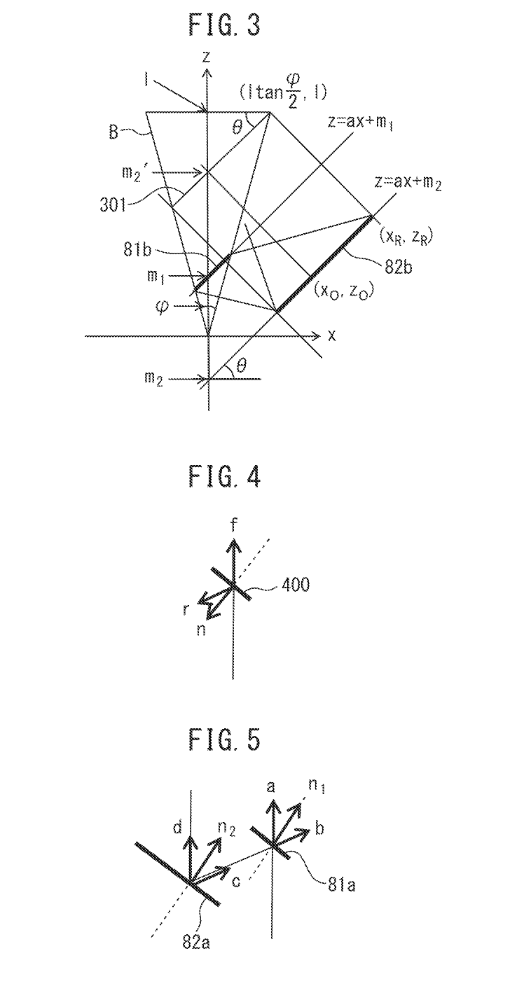

In the following, a positional relationship of each mirror will be described in detail with reference to FIG. 3 illustrating an arrangement of the pair of mirrors 81b and 82b for the right eye. In FIG. 3, a direction parallel to the entrance pupil plane of the imaging optical system of the imaging unit 2 is defined as x-axis and a direction parallel to the optical axis of the imaging unit 2 is defined as z-axis. Furthermore, the vertical direction is defined as y axis. Note that a horizontal plane at y=0 corresponds to a boundary plane between the pair of mirrors 81a and 82a for the left eye and the pair of mirrors 81b and 82b for the right eye. In addition, a horizontal angle of view of the imaging unit 2 is defined as φ and a tilt of the mirror 81b with respect to the x-axis is defined as θ (a=tan θ). Furthermore, a distance from the entrance pupil plane to the mirror 81b along the optical axis of the imaging unit 2 is defined as m₁ and a length along the optical axis from the entrance pupil to an opening surface on the object side of the stereo adapter 8 is defined as l.

In this case, a position to which a cut surface 301 with the angle θ, which passes an end point of an object-side opening surface of a flux B of a principal ray represented by a triangle spreading with the horizontal angle of view φ from the vertex of the entrance pupil plane toward the length l, is axisymmetrically moved with respect to the reflecting surface of the inner mirror 81b is a position of the outer mirror 82b. Note that the reflecting surface of the mirror 81b is represented by a straight line z=ax+m₁. From the above, a base line length B₂ which is a distance between a left-eye viewpoint and a right-eye viewpoint and a distance between left and right edges of each mirror of the stereo adapter 8 are formulated. In particular, coordinates (x_{R}, z_{R}) of a right edge of the mirror 82b and coordinates (x₀, z₀) of a point at which a principal ray parallel to the optical axis of the imaging unit 2 intersects the reflecting surface of the mirror 82b are calculated from their relationship with coordinates of points A(l tan ψ/2, l) and B(0, m₂′) which are their axisymmetric points with respect to the straight line z=ax+m₁.

In particular, the coordinates (x_{R}, z_{R}) of the right edge of the mirror 82b is calculated by the following equation.

$${x}_{R} = a ( l - \frac{{a}^{2} l + 2 al tan \frac{ϕ}{2} + 2 {m}_{1} - l}{{a}^{2} + 1} ) + l tan \frac{ϕ}{2} \\ {z}_{R} = \frac{{a}^{2} l + 2 al tan \frac{ϕ}{2} + 2 {m}_{1} - l}{{a}^{2} + 1} \qquad ( 1 )$$

When θ=45° (a=1), (x_{R}, z_{R}) are expressed as follows.

$${x}_{R} = l - {m}_{1} \text{:} non \text{-} dependent on φ \\ {z}_{R} = l tan \frac{ϕ}{2} + {m}_{1} \qquad ( 2 )$$

On the other hand, the coordinates (x₀, z₀) are obtained as follows.

$${x}_{0} = \frac{2 a ( {m}_{2}^{′} - {m}_{1} )}{{a}^{2} + 1} \\ {z}_{0} = \frac{( {a}^{2} - 1 ) {m}_{2}^{′} + 2 {m}_{1}}{{a}^{2} + 1} \\ {m}_{2}^{′} = l - al tan \frac{ϕ}{2} \qquad ( 3 )$$

When θ=45° (a=1), x₀ is expressed as follows.

$${x}_{0} = {m}_{2}^{′} - {m}_{1} = {x}_{R} - l tan \frac{ϕ}{2} \qquad ( 4 )$$

Since two times of x₀ is the base line length B₁, a half of the base line length B₁ is a value obtained by subtracting a half of the opening of the stereo adapter 8 from x_{R} when m₁ is fixed. In other words, when x_{R} is determined, the base line length B₁ can be made longer as the horizontal angle of view is smaller.

Next, a formulation of constraint conditions of the distance m₁ from the entrance pupil plane to the inner mirror 81b will be described. In order that the light flux B may not be vignetted by the mirror 81b, a left end of a ray entering into the outer mirror 82b from the object side is required to be positioned at a right side more than a right edge (x₁, z₁) of the mirror 81b. Coordinates (x_{L}, z_{L}), through which the left end of the ray passes, at a distance z_{R} from the entrance pupil plane (i.e., a distance from the entrance pupil plane to the right edge of the mirror 82b) are expressed by the following equation.

$$( {x}_{L} , {z}_{L} ) = ( {x}_{R} - 2 l tan \frac{ϕ}{2} , {z}_{R} ) \qquad ( 5 )$$

The coordinates (x₁, z₁) of a right edge of the mirror 81b is an intersection point of the straight line z=ax+m₁ representing the reflecting surface of the mirror 81b and a straight line z=x/tan(ψ/2) representing a right edge of the ray of the light flux B. Hence, the following equation holds.

$${x}_{L} = \frac{{m}_{1} tan \frac{ϕ}{2}}{1 - α tan \frac{ϕ}{2}} \leq {x}_{R} - 21 tan \frac{ϕ}{2} \qquad ( 6 )$$

When θ=45° (a=1) in the equation (6), the following equation holds since x_{R}=l−m₁.

$${m}_{1} \leq i ( 1 - 2 tan \frac{ϕ}{2} ) ( 1 - tan \frac{ϕ}{2} ) \qquad ( 7 )$$

In other words, the distance m₁ needs to be set so as to satisfy the equation (7).

Next, constrains of a forward tilt angle ψ of the outer mirrors 82a and 82b will be described. Note that the forward tilt angle is determined by the tilt angle θ of the mirror around the vertical axis and the vertical angle of view ψ_{V} of the imaging optical system of the imaging unit 2. For simplicity of explanation, it will be described for a case that the forward tilt angle α of the inner mirrors 81a and 81b is 0°. A determination method of the forward tilt angle of the outer mirrors 82a and 82b for a case that the forward tilt angle α is set to a value other than 0° will be described later.

In order that the image captured in the upper half and the image captured in the lower half of the image generated by the imaging unit 2 may include a common portion regardless of a distance from the imaging unit 2 to the subject, it is preferable that a ray corresponding to the center of the field of view of the upper half and a ray corresponding to the center of the field of view of the lower half become parallel on the subject side. In other words, it is preferable that the forward tilt angle ψ of the mirror 82a is determined such that a ray entering, in parallel to the optical axis of the imaging unit 2, into the center of the mirror 82a which directs a light flux to the upper half of the entrance pupil of the imaging unit 2, forms an angle of ψᵥ/4 in the vertical direction with respect to the optical axis when leaving from the stereo adapter 8. Similarly, it is preferable that the forward tilt angle (−ψ) of the mirror 82b is determined such that a ray entering, in parallel to the optical axis of the imaging unit 2, into the center of the mirror 82b which directs a light flux to the lower half of the entrance pupil of the imaging unit 2, forms an angle of ψᵥ/4 in the vertical direction with respect to the optical axis when leaving from the stereo adapter 8.

FIG. 4 is a diagram illustrating a relationship between an incident angle of an incident light to a reflecting surface and a reflection angle of a reflected light. In FIG. 4, a unit direction vector of an incident light to a reflecting surface 400 is defined as f, a normal vector of the reflecting surface 400 is defined as n, and a unit direction vector of a reflected light is defined as r. Since an incident angle is equal to a reflection angle, the following relationship holds among each of the vectors.

\vec{r}−\vec{f}−2(\vec{f}·\vec{n})\vec{n} (8)

For the pair of mirrors 81a and 82a for the left eye, a unit direction vector of a ray entering the inner mirror 81a from the imaging unit 2 is defined as a=(0, sin φᵥ/4, cos φᵥ/4), as illustrated in FIG. 5. Furthermore, a reverse vector of a normal vector to the reflecting surface of the mirror 81a is defined as n1=(sin θ, 0, cos θ) and a unit direction vector of a reflected light by the mirror 81a is defined as b=(x, y, z). In this case, the following equation holds from the equation (8).

\vec{b}=2(\vec{α}·\vec{n₁})\vec{n₁}−\vec{α} (9)

Accordingly, each element of the unit direction vector of the reflected light is as follows.

x=α sin 2θ,y=−β,z=αcos 2θ

α=cos φ_{V}/4,β=sin φ_{V}/4 (10)

Next, a reverse vector of a unit direction vector of an incident light to the outer mirror 82a is defined as c. Where c=b. Furthermore, in a case that the mirror 82a is rotated by the forward tilt angle ψ around the horizontal axis along the reflecting surface, a normal vector of the reflecting surface of the mirror 82a is defined as n2=(sin θ, −sin ψ, cos θ cos ψ). In addition, a unit direction vector of a reflected light by the mirror 82a is defined as d=(sin λ, 0, cos λ). In this case, the following equation holds from the relation (8).

\vec{d}=2(\vec{c}·\vec{n₂})\vec{n₂}−\vec{c} (11)

Accordingly, the following relationship holds.

x cos θ−z sin θ=−cos θ sin λ+sin θ cos λ

y=−2x sin θ sin ψ cos ψ+2y sin² ψ−2z cos θ sin ψ cos ψ (12)

Eliminating x, y, and z from the equation (12), it is possible to solve for λ and the forward tilt angle ψ from the rotation angle θ of the mirrors 81a and 82a around the vertical axis. In particular, when θ=45°, the forward tilt angle ψ can be expressed as follows, using the vertical angle of view φᵥ of the imaging unit 2.

$${cos}^{2} 2 φ = \frac{1}{2 {tan}^{2} \frac{{ϕ}_{v}}{4} + 1} \qquad ( 13 )$$

For example, when the horizontal angle of view of the imaging unit 2 is 30° and an aspect ratio of an image generated by the imaging unit 2 is 4:3, the vertical angle of view of the imaging unit 2 is 22.76°. In this case, from the equation (13), the forward tilt angle of the outer mirror 82a for the left-eye which directs a light flux from the subject to an upper side of the imaging unit 2 is approximately 4°. It is assumed that the forward tilt angle has a positive value when the reflecting surface faces below the horizontal plane. On the contrary, a backward tilt angle of the outer mirror 82b for the right eye which directs a light flux from the subject to a lower side of the imaging unit 2 is approximately −4°.

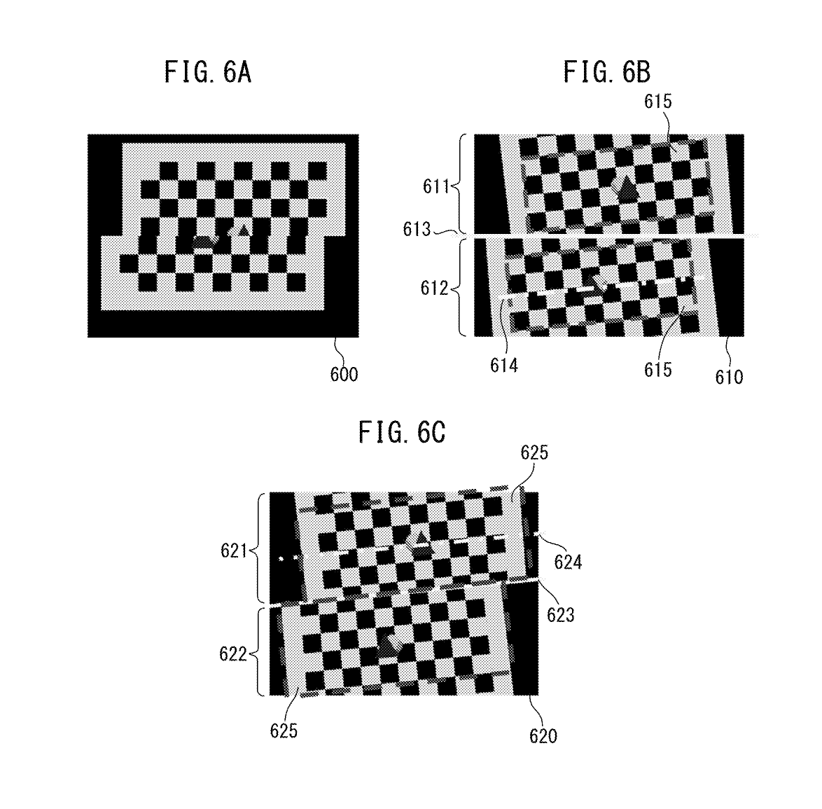

FIG. 6A represents an example of an image generated by the imaging unit 2 when the forward tilt angle of the outer mirrors 82a and 82b are 0°. In this case, since there are no common portions in a subject captured in an upper side and a subject captured in a lower side of an image 600, the stereo image generating apparatus is unable to generate a stereo image from the image 600. On the other hand, FIG. 6B represents an example of an image generated by the imaging unit 2 when the forward tilt angle of the inner mirrors 81a and 81b is set to 0° and the forward tilt angle of the mirrors 82a and 82b is set according to the equation (13). In this case, there is a common portion 615 in a subject captured in an upper side and a subject captured in a lower side of the image 610. Thus, the stereo image generating apparatus can generate a stereo image by trimming the common portion 615 from an upper half 611 and a lower half 612 of an image 610 to define as respectively a left image and a right image.

However, the subject rotates on the image due to forward-tilting the outer mirrors toward the optical axis OA side. Furthermore, the subject's images captured in the upper half and the lower half of the image are each distorted in a trapezoidal form. This is because, although a light flux above the optical axis of the imaging unit 2 and a light flux below the optical axis of the imaging unit 2 are intrinsically separated further apart as a distance from the imaging unit 2 increases, the centers of the two light fluxes become parallel to each other due to a fact that the outer mirrors of the stereo adapter 8 are tilted forward to the optical axis OA.

Furthermore, in the example illustrated in FIG. 6B, a boundary 613 between an upper half 611 and a lower half 612 of the image 610 is parallel to the horizontal direction but parallax directions 614 are tilted with respect to the horizontal direction in subject regions contained in the upper half 611 and the lower half 612. As a result, the common portion 615 common to the upper half 611 and the lower half 612 becomes significantly narrow compared to the subject regions of the upper half 611 and the lower half 612.

FIG. 6C represents an example of an image generated by the imaging unit 2 when a forward tilt angle of the inner mirrors 81a and 81b is adjusted according to a forward tilt angle of the outer mirrors 82a and 82b which is set according to the equation (13). In this example, a subject region 621 contained in an upper half of an image 620 and a subject region 622 contained in a lower half of the image 620 are also tilted with respect to the horizontal direction. Accordingly, a parallax direction 624 in each subject region and a boundary 623 between each of the subject regions become approximately parallel and, as a result, a common portion 625 of an upper half 621 and a lower half 622 is wider than the common portion 615 in the example illustrated in FIG. 6B.

In the following, a determination method of a forward tilt angle of the inner mirrors 81a and 81b in order to make a parallax direction parallel to a boundary between two regions in which the subject is captured by each pair of mirrors.

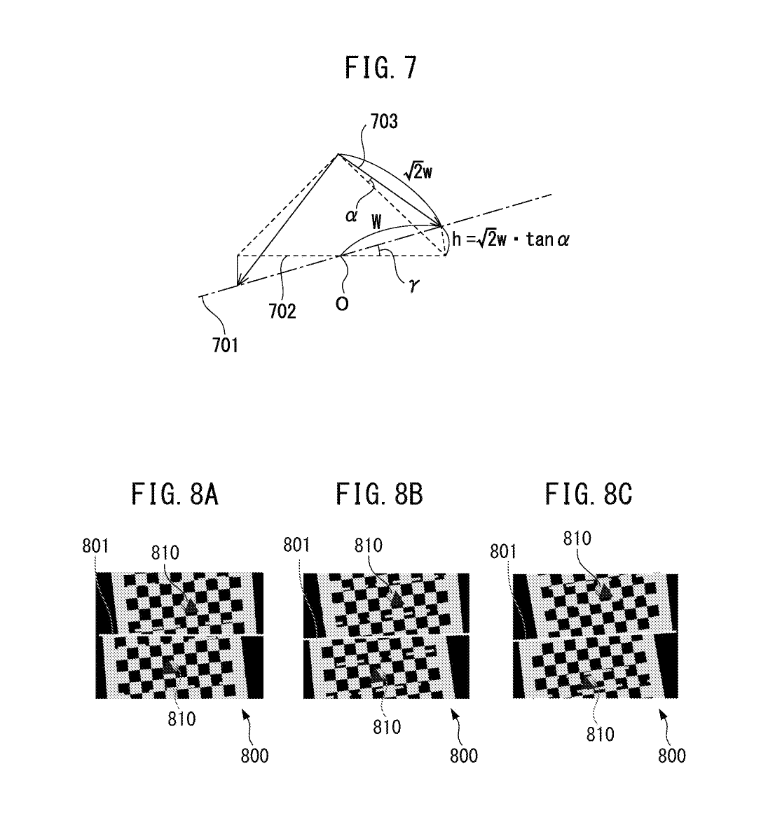

First, a relationship between a forward tilt angle of the inner mirrors 81a and 81b and a tilt with respect to the horizontal direction of a boundary between two regions in which the subject is captured on an image is explained with reference to FIG. 7. As illustrated in FIG. 7, when a tilt of a boundary 701 between two subject regions with respect to the horizontal direction 702 is defined as γ, the following equation holds.

$$tan γ - \frac{h}{w} \qquad ( 14 )$$

Where, w is a length from the center O to an end point of the boundary 701 between the two subject regions and h represents a height along the mirror 81a of the end point of the boundary 701 with respect to a horizontal line passing the center O. Note that the center O is a point to be set for convenience of explanation and is set, for example, such that a position thereof in the horizontal direction coincides with the optical axis OA of the imaging unit 2.

Note that a tilt of a boundary between two subject regions, in which the subject is captured on the image with respect to the horizontal direction, is equal to a tilt of a line at which a plane which is horizontal on the mirror 81a and parallel to a normal line of the mirror 81a intersects the object plane parallel to the image plane of the imaging unit 2 with respect to the horizontal direction.

It is assumed that the mirror 81a is disposed such that the reflecting surface of the mirror 81a forms 45° with respect to the optical axis OA in the horizontal plane passing through the optical axis OA. In this case, as illustrated in FIG. 7, a length from a point on the mirror 81a corresponding to the center O of the boundary 701 to the end point of the boundary 701 along an intersection line 703 between a plane, which is horizontal on the mirror 81a and parallel to the normal line of the mirror 81a, and the mirror 81a, is equal to tan 45°×w=√2w. In addition, when the mirror 81a is tilted forward by an angle α around a horizontal rotational axis parallel to the reflecting surface, the following equation holds.

$$tan α = \frac{h}{\sqrt{2} w} \qquad ( 15 )$$

By combining the equations (14) and (15), a tilt γ of the boundary between the two upper and lower subject regions with respect to the horizontal direction is expressed by the following equation by the forward tilt angle α of the mirror 81a.

tan γ=\sqrt{2} tan α (16)

FIGS. 8A to 8C respectively illustrate examples of a combination of the forward tilt angle α of the inner mirrors 81a and 81b and the tilt γ of a boundary 801 between two upper and lower subject regions on an image 800 with respect to the horizontal direction. FIG. 8A corresponds to α=γ=0°, FIG. 8B corresponds to α=1° and γ=1.4° and FIG. 8C corresponds to α=2° and γ=2.8°.

As illustrated in FIGS. 8A to 8C, it can be seen that the tilt γ increases as the forward tilt angle α of the mirrors 81a and 81b increases. On the other hand, as the forward tilt angle α increases, a distance from the boundary 801 to subjects 810 represented in each of the upper and lower regions also increases. Therefore, a relationship between a position of the subject in the upper subject region and a position of the subject in the lower subject region in a direction perpendicular to the parallax direction changes in accordance with the forward tilt angle α of the mirrors 81a and 81b.

However, in order to generate a stereo image by trimming a left image and a right image respectively from the upper and lower subject regions, it is preferable that a position of the subject in the direction perpendicular to the parallax direction in a common portion between the upper and lower subject regions coincides in the upper and lower subject regions. Therefore, in the present embodiment, by appropriately setting the forward tilt angle of each mirror, a positional shift of the subject in the direction perpendicular to the parallax direction in each subject region is suppressed while a difference between a tilt of the boundary between the upper and lower subject regions and a tilt of the parallax direction in the subject regions are suppressed.

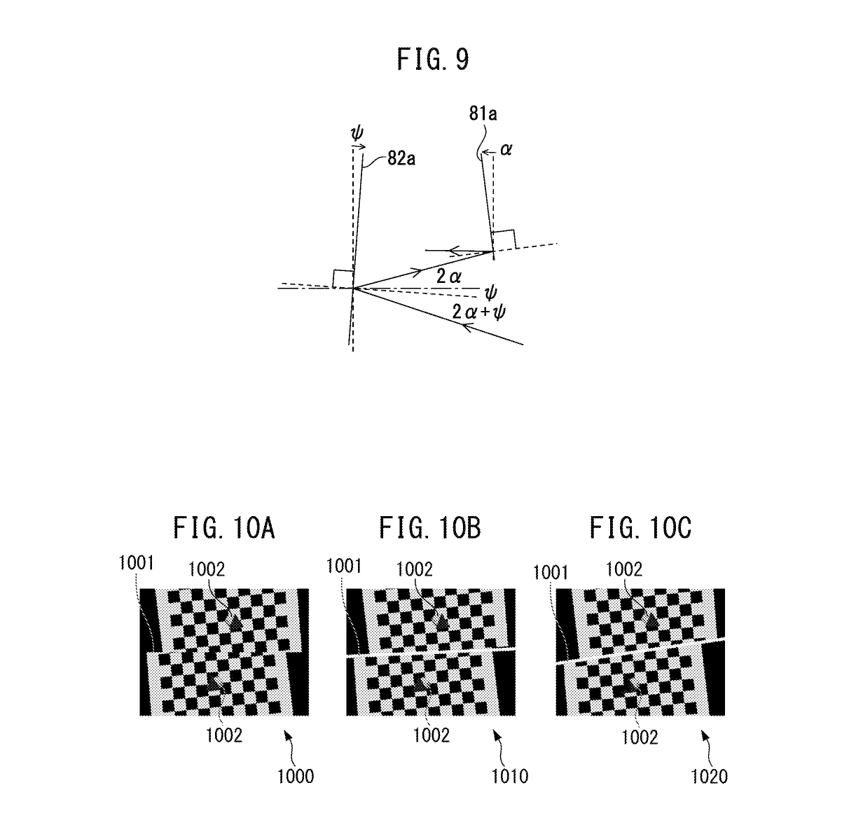

FIG. 9 is a diagram illustrating a trajectory of a ray in the vertical direction when the inner mirror 81a and the outer mirror 82a each are disposed so as to form an angle of 45° in the horizontal plane with respect to the optical axis OA of the imaging unit 2.

The forward tilt angle of the inner mirror 81a is defined as α and the forward tilt angle of the outer mirror 82a is defined as ψ. In this case, an angle which a ray entering the stereo adapter 8 forms with respect to the horizontal plane is 2(α+ψ) in order that a ray entering the imaging unit 2 by being reflected by the inner mirror 81a may be parallel to the optical axis OA of the imaging unit 2. Therefore, if a condition of the following equation is satisfied, it is possible to keep an angle of the ray entering the imaging unit 2 with respect to the optical axis OA constant. In other words, the position of the subject on the image in the direction perpendicular to the parallax direction will not be shifted.

α+ψ=a constant value (17)

FIGS. 10A to 10C are diagrams illustrating simulation results of a capturing image obtained according to a combination of α and ψ satisfying a condition of the equation (17). FIG. 10A represents an image 1000 when α=0° and ψ=4°. FIG. 10B represents an image 1010 when α=3° and ψ=1°. FIG. 10C represents an image 1020 when α=6° and ψ=−2°. It can be seen that, in any of the images, a distance from a boundary 1001 between upper and lower subject regions to a subject 1002 is kept approximately constant in the upper subject region and the lower subject region.

Accordingly, α and ψ are determined such that a tilt of a parallax direction in a subject region and a tilt of a boundary between upper and lower subject regions on an image coincide while satisfying the above condition. α and ψ are determined according to the following flow.

Step 1: Determination of a tilt Δ of a parallax direction in a subject region on an image.

The tilt Δ of the parallax direction is determined by a vertical angle of view φ_{V} of the imaging unit 2. As described above, it is preferable that a common portion between the subject's image contained in an upper half and the subject's image contained in a lower half of an image generated by the imaging unit 2 exits. In this case, it is preferable that, regardless of a distance from the imaging unit 2 to a subject, a ray corresponding to the center of a field of view of the upper half (i.e., a ray with an incident angle of a quarter of a vertical angle of view φ_{V} with respect to the optical axis when entering the imaging unit 2) and a ray corresponding to the center of a field of view of a lower half of the imaging unit 2 are parallel in a subject side. In this case, the tilt of the parallax direction in the subject region on the image is given by the following equation.

Δ=φ_{V}/4 (18)

Step 2: Determination of the forward tilt angle α of the inner mirror.

The tilt Δ of the parallax direction in the subject region and a tilt γ of the boundary between the upper and lower subject regions on the image are made equal in accordance with the equation (16). In other words, by setting γ=Δ, the forward tilt angle α of the inner mirror is determined according to the following equation.

tan Δ=\sqrt{2} tan α (19)

Step 3: Determination of the forward tilt angle γ of the outer mirror.

It is preferable that the constant value of the right side of the equation (17) is determined such that a ray corresponding to the center of the upper half of the field of view and a ray corresponding to the center of the lower half of the field of view of the imaging unit 2 are parallel in the subject side. Therefore, the constant value can be the forward tilt angle of the outer mirror when the forward tilt angle α of the inner mirror expressed by the equation (13) is 0°. Accordingly, the following equation holds from the equations (13) and (17).

$$α + ϕ = \frac{1}{2} {cos}^{- 1} \sqrt{\frac{1}{2 {tan}^{2} \frac{{φ}_{V}}{4} + 1}} \qquad ( 20 )$$

As expressed in the equations (18) to (20), α and γ are both determined based on the vertical angle of view φ_{V} of the imaging unit 2.

For example, it is assumed that the inner mirror 81a and the outer mirror 82a each are disposed to form an angle of 45° in the horizontal plane with respect to the optical axis OA of the imaging unit 2. Furthermore, it is assumed that the horizontal angle of view of the imaging unit 2 is 30° and an aspect ratio of the image plane is 3:4. In this case, since the vertical angle of view ψ_{V} of the imaging unit 2 is equal to 22.726°, the forward tilt angle α of the inner mirror 81a is 4.024° from the equations (18) and (19). In addition, the forward tilt angle ψ of the outer mirror 82a is −0.001964° from the equation (20), assuming that the forward tilt angle α is equal to 4.024°.

In the present embodiment, the reflecting surfaces of the inner mirrors 81a and 81b each are tilted toward the optical axis OA from a plane orthogonal to the optical axis OA of the imaging unit 2. Therefore, a lower end of a light flux passing via the inner mirror 81a and the outer mirror 82a passes below a lower end of the inner mirror 81a. Therefore, it is preferable that an upper end of the inner mirror 81b located below the inner mirror 81a is cut in a plane passing through the optical axis OA of the imaging unit 2 and orthogonal to the inner mirror 81a so as not to block a light flux passing via the inner mirror 81a and the outer mirror 82a. Similarly, it is preferable that a lower end of the inner mirror 81a is cut in a plane passing through the optical axis OA of the imaging unit 2 and orthogonal to the inner mirror 81b.

Alternatively, the inner mirror 81b may be disposed with a space between the optical axis OA and the upper end of the inner mirror 81b such that the upper end of the inner mirror 81b does not intersect the plane passing through the optical axis OA of the imaging unit 2 and orthogonal to the inner mirror 81a. Similarly, the inner mirror 81a may be disposed with a space between the optical axis OA and the lower end of the inner mirror 81a such that the lower end of the inner mirror 81a does not intersect the plane passing through the optical axis OA of the imaging unit 2 and orthogonal to the inner mirror 81b.

As described above, when the stereo adapter 8 is mounted on the imaging unit 2 such that the horizontal direction of the stereo adapter 8 and the horizontal direction of the image plane of the imaging unit 2 coincide, a subject on the image rotates due to tilting the inner and outer mirrors.

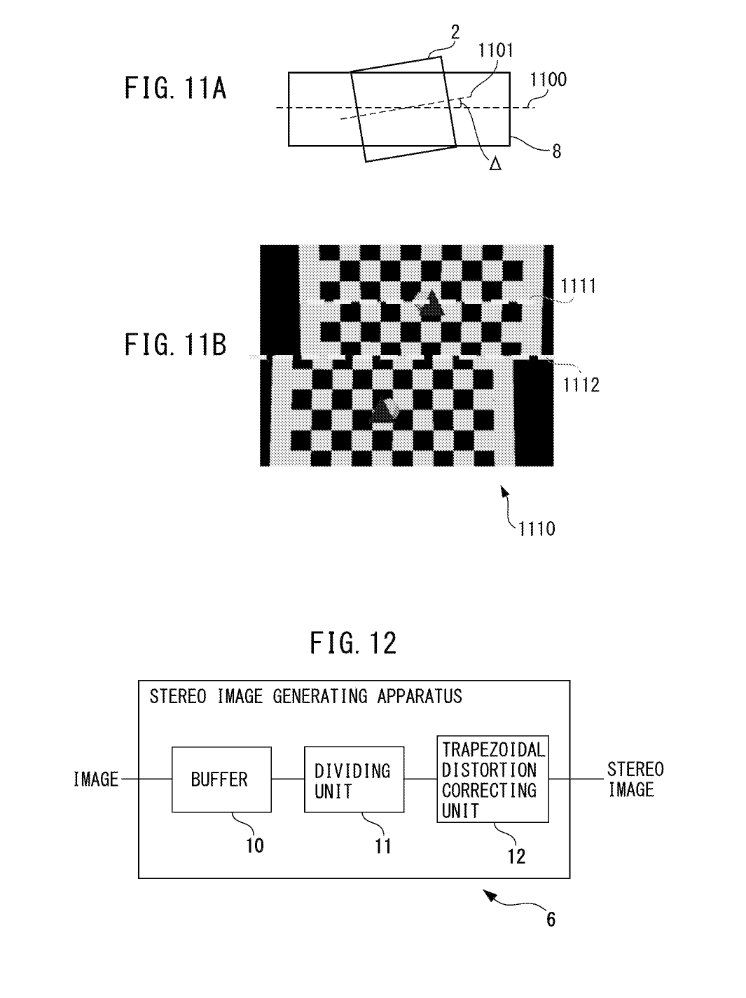

The rotation of the subject is corrected by rotating the imaging unit 2 or the stereo adapter 8 using the optical axis OA of the imaging unit 2 as a rotational axis such that the horizontal direction of the imaging unit 2 is tilted with respect to the horizontal direction of the stereo adapter 8 by an angle which cancels the tilt of the parallax direction with respect to the horizontal direction on the image. As illustrated in FIG. 11A, the imaging unit 2 may be rotated using the optical axis OA as a rotational axis such that the horizontal direction 1101 of the imaging unit 2 is tilted by the angle Δ given by the equation (18) with respect to the horizontal direction (i.e., the parallax direction) 1100 of the stereo adapter 8. As in the example above, when the vertical angle of view φ_{V} of the imaging unit 2 is equal to 22.726°, a rotation angle of the imaging unit 2 is 5.6815°.

FIG. 11B is a diagram illustrating an example of an image in which a rotation of a subject is corrected by a rotation of the imaging unit 2 with respect to a horizontal direction of the stereo adapter 8. As illustrated in FIG. 11B, on the image 1110, it can be seen that a parallax direction 1111 in each subject region and a boundary 1112 between upper and lower subject regions are approximately parallel with respect to the horizontal direction. Accordingly, an upper half and a lower half of the image can be respectively used as a left image and a right image without correcting the rotation of the subject.

However, a subject's image contained in the upper half and a subject's image contained in the lower half of the image each are distorted into a trapezoidal shape due to the outer and inner mirrors being tilted. Therefore, the stereo image generating apparatus 6 trims the upper half and the lower half of the image generated by the imaging unit 2 respectively as the left image and the right image and corrects trapezoidal distortion of the subject in the left image and the right image. Thereby, the stereo image generating apparatus 6 generates a stereo image having a set of the left image and the right image.

In the following, the stereo image generating apparatus 6 will be explained in detail. In FIG. 12, a configuration diagram of the stereo image generating apparatus 6 is illustrated. The stereo image generating apparatus 6 includes a buffer 10, a dividing unit 11, and a trapezoidal distortion correcting unit 12. Each unit included in the stereo image generating apparatus 6 may be implemented in the stereo image generating apparatus 6 as a separate circuit or may be a single integrated circuit which realizes a function of each unit thereof.

Alternatively, the stereo image generating apparatus 6 may be combined into one unit with the control unit 7. In this case, each unit included in the stereo image generating apparatus 6 may be implemented, for example, as a functional module which is realized by a computer program executed on a processor included in the control unit 7. Various types of data generated by the stereo image generating apparatus, or ones used by the stereo image generating apparatus are stored in the storage unit 5.

The buffer 10 includes, for example, a volatile semiconductor memory circuit and temporarily stores an image generated by the imaging unit 2 and inputted to the stereo image generating apparatus 6. Furthermore, the buffer 10 may temporarily store a left image and a right image trimmed by the dividing unit 11.

The dividing unit 11 divides an image obtained by shooting a subject using the stereo adapter 8 into an upper half and a lower half. The divided upper half corresponds to a portion in which the subject's image formed by a light flux directed by a pair of mirrors for the left eye of the stereo adapter 8 is formed. On the other hand, the divided lower half corresponds to a portion in which the subject's image formed by a light flux directed by a pair of mirrors for the right eye of the stereo adapter 8 is formed. The dividing unit 11 sets the upper half of the image to the left image and the lower half of the image to the right image.

Note that, when vignetting of the light flux by a housing or any mirror of the stereo adapter 8 occurs, the dividing unit 11 may trim a region corresponding to a range, in which the light flux enters, within the upper half of the image to set to the left image. Similarly, the dividing unit 11 may trim a region corresponding to a range, in which the light flux enters, within the lower half of the image to set to the right image. The dividing unit 11 outputs the left image and the right image to the trapezoidal distortion correction unit 12.

Since the inner and outer mirrors of the stereo adapter 8 are tilted around an axis of the horizontal direction, an object plane corresponding to the image plane of the imaging unit 2 is tilted due to a light passing through the stereo adapter 8. Accordingly, an object on the object plane parallel to the image plane is to be projected obliquely with respect to the image plane by the stereo adapter 8 and the imaging unit 2. As a result, a shape of the subject is distorted trapezoidally on the image generated by the imaging unit 2.

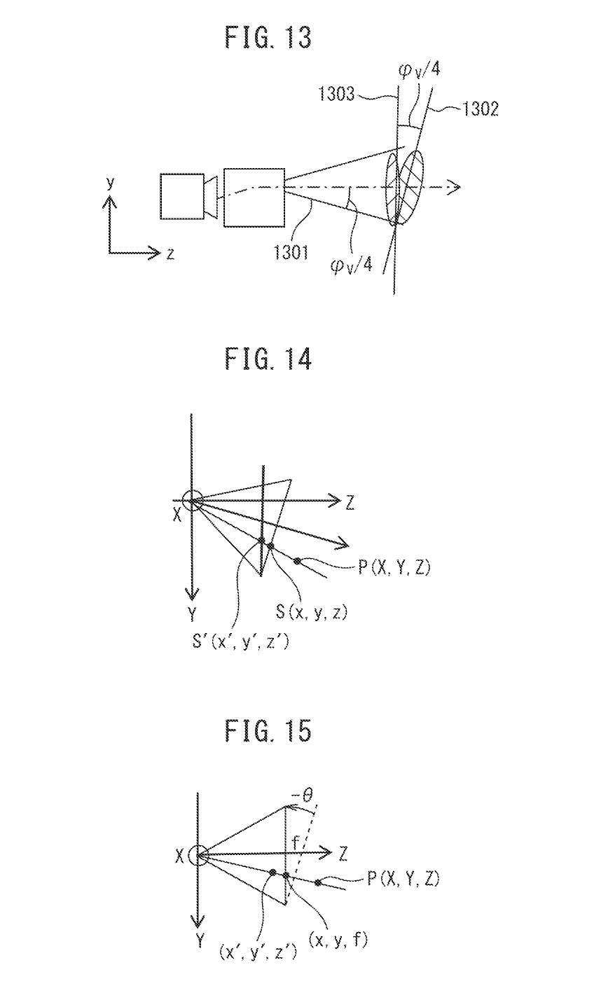

The trapezoidal distortion correcting unit 12 corrects trapezoidal distortion due to the oblique projection. First, trapezoidal distortion generated on an image is examined. As illustrated in FIG. 13, it is focused on a fact that a plane 1302 orthogonal to a ray 1301 which becomes a ray along the optical axis of the imaging unit 2 by passing through the stereo adapter 8 forms an image on the image plane of the imaging unit 2 without trapezoidal distortion. The trapezoidal distortion correcting unit 12 can correct the trapezoidal distortion by performing a planar-projective-transformation of the plane with respect to a vertical plane 1303. In the present embodiment, the forward tilt angle of each mirror is set such that a ray parallel to the optical axis of the imaging unit 2 is tilted by φ_{V}/4 with respect to the optical axis due to passing through the stereo adapter 8. Therefore, a tilt angle of the plane 1302 with respect to the vertical plane 1303 is φ_{V}/4 from a relationship between complementary angles of a right triangle.

With respect to trapezoidal distortion correction of an image, a matrix equation for correcting the image represented by a camera coordinate system (u,v) is given by a planar projective transformation of 3×3. As illustrated in FIG. 14, in order to obtain the planar projective transformation, coordinates (x, y, z) of a point s of an image plane of a camera whose optical axis coincides with the Z axis and coordinates (x′, y′, z′) of a point s′ of an image plane of a camera whose optical axis is rotated by θ° around the X axis, corresponding to a point P (X, Y, Z) of World coordinates, are obtained. In addition, a desired planar projective matrix is obtained by transforming the coordinates (x, y, z) and (x′, y′, z′) to points (u, v) and (u′, v′) on the camera coordinate system of the camera and by obtaining a corresponding relationship from the coordinates (u, v) to (u′, v′). Note that the World coordinate system is defined as a right handed system so that transformation to the camera coordinate system is easily understood.

A model of the planar projective transformation illustrated in FIG. 14 is also given on a coordinate system obtained by rotating the coordinate system illustrated in FIG. 14 by −θ around the X axis as illustrated in FIG. 15 without loss of generality (note, however, that θ is positive for a clockwise direction). Where, coordinates (x′, y′, z′) are an intersection of equations (y−h)=tan(90−θ)(z−f)=(1/tan θ)(z−f) and y=(Y/Z)z. From these equations, z′ is calculated as follows.

$${z}^{t} = \frac{f - h tan θ}{Z - Y tan θ} Z \qquad ( 21 )$$

Note that f represents a focal length of the camera.

In addition, from relational equations of x′=(z′/Z)X and y′=(z′/Z)Y, a perspective transformation equation by the camera is obtained as follows.

$${s}^{′} ( \begin{matrix}{x}^{′} \\ {y}^{′} \\ 1\end{matrix} ) = ( \begin{matrix}f - h tan θ & 0 & 0 \\ 0 & f - h tan θ & 0 \\ 0 & - tan θ & 1\end{matrix} ) ( \begin{matrix}X \\ Y \\ Z\end{matrix} ) \qquad ( 22 )$$

On the other hand, a perspective transformation with respect to coordinates (x, y, z) is given by the following equation since it corresponds to a case of θ=0 in the equation (22).

$$s ( \begin{matrix}x \\ y \\ 1\end{matrix} ) ( \begin{matrix}f & 0 & 0 \\ 0 & f & 0 \\ 0 & 0 & 1\end{matrix} ) ( \begin{matrix}X \\ Y \\ Z\end{matrix} ) \qquad ( 23 )$$

The following equation is obtained by eliminating (X, Y, Z) from the two perspective transformation equations and, furthermore, redefining s′/s as s′.

$${s}^{′} ( \begin{matrix}{x}^{′} \\ {y}^{′} \\ 1\end{matrix} ) = ( \begin{matrix}1 - \frac{h}{f} tan θ & 0 & 0 \\ 0 & 1 - \frac{h}{f} tan θ & 0 \\ 0 & - \frac{tan θ}{f} & 1\end{matrix} ) ( \begin{matrix}X \\ Y \\ 1\end{matrix} ) \qquad ( 24 )$$

In addition, the points (u, v) and (u′, v′) on the camera coordinate system are mapped in order to transform from the World coordinate system to the camera coordinate system. Where, a relationship between the coordinates (x, y, z) of the image plane of the camera whose optical axis coincides with the Z axis and the corresponding coordinates (u, v) on the camera coordinate system of the camera is expressed by the following equation.

u=X+w,v=y+h

∴x=u−w,y=v−h (25)

Similarly, a relationship between the coordinates (x′, y′, z′) of the image plane of the camera whose optical axis is rotated by θ° around the X axis and the corresponding coordinates (u, v) on the camera coordinate system of the camera is expressed by the following equation.

$${u}^{′} = {x}^{′} + w , {v}^{′} = \frac{{y}^{′} - ( 1 - 2 cos θ ) h}{cos θ} \\ ∴ {x}^{′} = {u}^{′} - w , {y}^{′} = {v}^{′} cos θ - ( 2 cos θ - 1 ) h \qquad ( 26 )$$

By substituting the equations (25) and (26) into the equation (24), and thereby transforming the equation (24) to an equation expressed by the camera coordinate systems (u, v) and (u′, v′), a desired correction equation is obtained.

$${s}^{′} ( \begin{matrix}{u}^{′} \\ {v}^{′} \\ 1\end{matrix} ) ( \begin{matrix}1 - \frac{w}{f} tan θ & - \frac{h}{f} tan θ & \frac{w}{f} tan θ \cdot 2 h \\ 0 & \frac{1}{cos θ} - 2 \frac{w}{f} tan θ & ( 1 - \frac{1}{cos θ} + \frac{h}{f} tan θ ) \cdot 2 h \\ 0 & - \frac{tan θ}{f} & 1 + \frac{h}{f} tan θ\end{matrix} ) ( \begin{matrix}u \\ v \\ 1\end{matrix} ) \\ \frac{w}{f} = tan \frac{FOVH}{2} \\ \frac{h}{f} = tan \frac{FOVV}{2} \qquad ( 27 )$$

Where, FOVH represents a horizontal angle of view of the camera and FOVV represents a vertical angle of view of the camera.

The trapezoidal distortion correcting unit 12 can correct trapezoidal distortion of a subject by transforming coordinates of each pixel of its left and right images according to the equation (27). Where, FOVH and FOVV are respectively the horizontal angle of view and the vertical angle of view of the imaging unit 2 and f is the focal length of the imaging unit 2. In addition, since the object plane corresponding to the image plane of the imaging unit 2 is tilted by φ_{V}/4 by each mirror of the stereo adapter 8 in the present embodiment, θ may be set to φ_{V}/4 in the equation (27).

The left image and the right image whose trapezoidal distortion is corrected by the trapezoidal distortion correcting unit 12 may be used as a stereo image. The stereo image generating apparatus 6 causes the display unit 4 to display or the storage unit 5 to store the obtained stereo image.

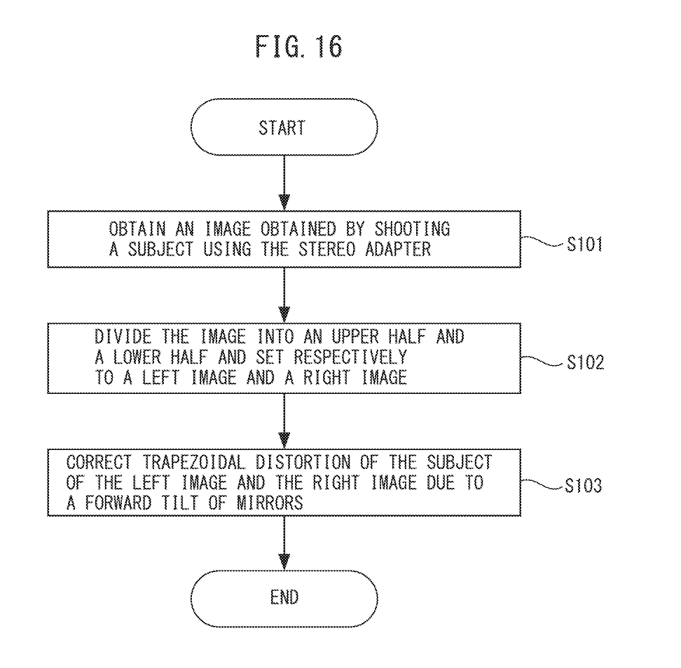

FIG. 16 is an operational flowchart of a stereo image generation process executed by the stereo image generating apparatus 6.

The stereo image generating apparatus 6 obtains an image obtained by shooting a subject using the stereo adapter 8 from the imaging unit 2 (step S101). The stereo image generating apparatus 6 stores the image in the buffer 10. The dividing unit 11 retrieves the image from the buffer 10. Then, the dividing unit 11 divides the image into an upper half corresponding to a pair of mirrors for the left eye and a lower half corresponding to a pair of mirrors for the right eye and sets them respectively to a left image and a right image (step S102).

The trapezoidal distortion correcting unit 12 corrects trapezoidal distortion of the subject due to a forward tilt angle of the mirrors (step S103). The stereo image generating apparatus 6 outputs, as a stereo image, a set of the left image and the right image in which the trapezoidal distortion of the subject is corrected and terminates the stereo image generating process.

As has been explained in the above, a stereo imaging apparatus equipped with the stereo adapter bisects a field of view of an imaging unit in a direction perpendicular to a parallax direction and directs a light flux for the left eye and a light flux for the right eye respectively to an upper half and a lower half of the field of view. Therefore, the stereo imaging apparatus can generate a stereo image whose angle of view of the parallax direction is wide. In addition, the stereo imaging apparatus can approximately parallelize the parallax direction on the image and a boundary between respective subject regions formed by each light flux by adjusting the forward tilt angle of each mirror included in the stereo adapter. Accordingly, the stereo imaging apparatus can make a common portion to all subject regions wide.

Note that, according to a modified example, the stereo adapter 8 may be mounted on the imaging unit 2 such that the horizontal direction (the parallax direction) of the stereo adapter 8 and the horizontal direction of the imaging unit 2 coincide. In this case, the stereo image generating apparatus may rotate, according to an affine transformation, each pixel of the left image and the right image by an angle which cancels a tilt of the parallax direction with respect to the horizontal direction on the image. In other words, the stereo image generating apparatus may rotate each pixel of the left image and the right image by an angle Δ given by the equation (18).

Note that, according to a modified example, instead of a pair of mirrors for the left eye and a pair of mirrors for the right eye included in the stereo adapter, prisms with a reflecting surface corresponding to a reflecting surface of the inner mirror and a reflecting surface corresponding to a reflecting surface of the outer mirror may be used. Alignment when mounting the prisms on the stereo adapter can be made simpler than alignment when mounting the pairs of mirrors on the stereo adapter since a positional relationship between the reflecting surfaces is fixed in the prisms.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A stereo adapter which is disposed in a front of an imaging unit which generates an image by shooting a subject, the stereo adapter comprising:
first and second reflecting surfaces which are disposed in the front of the imaging unit along a direction perpendicular to a parallax direction;
a third reflecting surface which is disposed at a position further away from the imaging unit along the parallax direction than the first reflecting surface; and
a fourth reflecting surface which is disposed at a position further away from the imaging unit along the parallax direction than the second reflecting surface and at a position opposite to the third reflecting surface with respect to an optical axis of the imaging unit, wherein
the first reflecting surface is rotated by a first angle with respect to an entrance pupil plane of the imaging unit around a first axis orthogonal to the parallax direction and the optical axis so as to face the imaging unit and the third reflecting surface and is rotated by a second angle from a direction perpendicular to a plane including the optical axis and the parallax direction toward the optical axis around an axis parallel to the first reflecting surface and orthogonal to the first axis,
the third reflecting surface is rotated by the first angle with respect to an object plane, which is in an image-forming relationship with an image plane of the imaging unit, around the first axis so as to face the first reflecting surface and the subject and is rotated by a third angle from a direction perpendicular to the plane including the optical axis and the parallax direction around an axis parallel to the third reflecting surface and orthogonal to the first axis,
the second reflecting surface is rotated by the first angle with respect to the entrance pupil plane of the imaging unit in a direction opposite to a rotational direction of the first reflecting surface around the first axis so as to face the imaging unit and the fourth reflecting surface and is rotated by the second angle from the direction perpendicular to the plane including the optical axis and the parallax direction toward the optical axis around an axis parallel to the second reflecting surface and orthogonal to the first axis,
the fourth reflecting surface is rotated by the first angle in a direction opposite to a rotational direction of the third reflecting surface with respect to the object plane around the first axis so as to face the second reflecting surface and the subject and is rotated by the third angle in a direction opposite to a rotational direction of the third reflecting surface from the direction perpendicular to the plane including the optical axis and the parallax direction around an axis parallel to the fourth reflecting surface and orthogonal to the first axis,
a total of the second angle and the third angle is set such that a ray parallel to the optical axis of the imaging unit when entering the stereo adapter among a first light flux which enters the imaging unit from the subject via the third reflecting surface and the first reflecting surface approaches the optical axis with an angle of a quarter of a vertical angle of view of the imaging unit with respect to the optical axis when leaving from the stereo adapter.

2. The stereo adapter according to claim 1, wherein the second angle is set such that a boundary between a first subject region which is generated by the first light flux and a second subject region which is generated by a second light flux which enters the imaging unit from the subject via the fourth reflecting surface and the second reflecting surface on the image becomes parallel to the parallax direction on the image.

3. A stereo imaging apparatus comprising:
an imaging unit which generates an image by shooting a subject;
a stereo adapter which is disposed in a front of the imaging unit, splits a light from the subject into a first light flux and a second light flux along a parallax direction, and directs the first and second light fluxes such that the first and second light fluxes are side by side in a direction perpendicular to the parallax direction when entering the imaging unit; and
a stereo image generating unit which generates a stereo image based on the image, wherein
the stereo adapter comprises:
first and second reflecting surfaces which are disposed in the front of the imaging unit along the direction perpendicular to the parallax direction;
a third reflecting surface which is disposed at a position further away from the imaging unit along the parallax direction than the first reflecting surface; and
a fourth reflecting surface which is disposed at a position further away from the imaging unit along the parallax direction than the second reflecting surface and at a position opposite to the third reflecting surface with respect to an optical axis of the imaging unit, wherein
the first reflecting surface is rotated by a first angle with respect to an entrance pupil plane of the imaging unit around a first axis orthogonal to the parallax direction and the optical axis so as to face the imaging unit and the third reflecting surface and is rotated by a second angle from a direction perpendicular to a plane including the optical axis and the parallax direction toward the optical axis around an axis parallel to the first reflecting surface and orthogonal to the first axis,
the third reflecting surface is rotated by the first angle with respect to an object plane, which is in an image-forming relationship with an image plane of the imaging unit, around the first axis so as to face the first reflecting surface and the subject and is rotated by a third angle from a direction perpendicular to the plane including the optical axis and the parallax direction around an axis parallel to the third reflecting surface and orthogonal to the first axis,
the second reflecting surface is rotated by the first angle with respect to the entrance pupil plane of the imaging unit in a direction opposite to a rotational direction of the first reflecting surface around the first axis so as to face the imaging unit and the fourth reflecting surface and is rotated by the second angle from the direction perpendicular to the plane including the optical axis and the parallax direction toward the optical axis around an axis parallel to the second reflecting surface and orthogonal to the first axis, the fourth reflecting surface is rotated by the first angle in a direction opposite to a rotational direction of the third reflecting surface with respect to the object plane around the first axis so as to face the second reflecting surface and the subject and is rotated by the third angle in a direction opposite to a rotational direction of the third reflecting surface from the direction perpendicular to the plane including the optical axis and the parallax direction around an axis parallel to the fourth reflecting surface and orthogonal to the first axis,
a total of the second angle and the third angle is set such that a ray parallel to the optical axis of the imaging unit when entering the stereo adapter among the first light flux which enters the imaging unit from the subject via the third reflecting surface and the first reflecting surface approaches the optical axis with an angle of a quarter of a vertical angle of view of the imaging unit with respect to the optical axis when leaving from the stereo adapter,
the stereo image generating unit comprises:
a dividing unit which divides the image along the direction perpendicular to the parallax direction into a first region on which the first light flux is incident and a second region on which the second light flux is incident, sets the first region to a first sub-image for an eye among the stereo image, and sets the second region to a second sub-image for the other eye among the stereo image; and
a trapezoidal distortion correcting unit which corrects trapezoidal distortion of the subject on the first and second sub-images.

4. The stereo imaging apparatus according to claim 3, wherein the stereo adapter is mounted on the imaging unit such that the parallax direction of the stereo adapter is tilted with respect to a horizontal direction of the imaging unit to so that the parallax direction on the image coincides with the horizontal direction of the imaging unit.
